(19) United States
(12) Patent Application Publication
(10) Pub. No.: US 2010/0312900 A1
(43) Pub. Date: Dec. 9, 2010

(54) METHOD, COMPUTER PROGRAM PRODUCT, AND APPARATUS FOR PROVIDING AN OBSERVER DEVICE WITH ACCESS TO A COMMUNICATION SESSION

(75) Inventor: Brian K. Daigle, Atlanta, GA (US)

Correspondence Address: AT&T Legal Department - PK;Attn: Patent Docketing, One AT&T Way, Room 2A-207, Bedminster, NJ, 07921, US

(73) Assignee: AT&T INTELLECTUAL PROPERTY I, L.P., Reno, NV (US)

(21) Appl. No.: 12/481,514

(22) Filed: Jun. 9, 2009

(51) Int. Cl. G06F 15/173

(52) U.S. Cl. 709/228

(57) ABSTRACT

An observer device is provided with access to a communication, session between participant devices. A request for initiating a communication session between a host participant device and at least one other participant device is received. The communication session between the host participant device and the at least one other participant device is established, and a connection between the host participant device and the observer device is also established. The observer device is provided with access to the communication session between the host participant device and the other participant device via the connection between the host participant device and the observer device. Awareness of the other participant device of the observer device's access to the communication session depends on access rules controlling access of the observer device to the communication session.

### BACKGROUND

Exemplary embodiments relate to observing a communication session between participants in a communication environment.

Messaging and communication applications, such as instant messaging, email, and Voice over Internet Protocol (VoIP), have gained immense popularity with the growth of the Internet, Typically, participants in an instant messaging session, email exchange, or VoIP conversation are required to register with a server, and messages and voice data are exchanged via the server and a communications network.

As instant messaging, email, and VoIP have become popular forms of communication, so has the practice of “lurking”. A lurker is a user that is able to observe communications between participants in a messaging session or conversation, often without any of the participants being aware of the lurker's presence.

### SUMMARY

It should be appreciated that this Summary is provided to introduce a selection of concepts in a simplifed form, the concepts being further described below in the Detailed Description. This Summary is not intended to identify key features or essential features of this disclosure, nor is it intended to limit the scope of the invention.

According to an exemplary embodiment, a method provides an observer device with access to a communication session between participant devices. A request for initiating a communication session between a host participant device and at least one other participant device is received. The communication session is established, via a communication network, between the host participant device and the at least one other participant device. A connection between the host participant device and the observer device is also established. The observer device is provided with access to the communication session between the host participant device and the at least one other participant device via the connection between the host participant device and the observer device. Awareness of the other participant device of the observer device's access to the communication session depends on access rules controlling access of the observer device to the communication session.

According to another embodiment, a computer program product includes a computer readable storage medium having encoded instructions stored thereon. When executed by a computer including a processor and a memory, the encoded instructions cause the computer to receive a request for initiating a communication session between a host participant device and at least one other participant device. The instructions further cause the computer to establish the communication session between the host participant device and the at least one other participant device, establish a connection between the host participant device and the observer device, and enable the observer device to access the communication session between the host participant device and the at least one other participant device via the connection between the host participant device and the observer device. Awareness of the other participant device of the observer device's access to the communication session depends on access rules controlling access of the observer device to the communication session.

According to another embodiment, an apparatus provides an observer device with access to a communication session between participant devices. The apparatus includes at least one interface for receiving a request for initiating a communication session between participant devices. The apparatus further includes a processor for controlling access to the communication session by the observer device. The communication session is established between the host device and at least one other participant device, and the processor enables the observer device to access the communication session between the host participant device and the at least one other participant device via a connection between the host participant device and the observer device. Awareness of the other participant device of the observer device's access to the communication session depends on access rules stored in the memory for controlling access of the observer device to the communication session.

Other methods, computer program products, and/or systems according to various embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 illustrates a communication environment according to an exemplary embodiment.

FIG. 2 is a flowchart illustrating a method for providing an observer device with access to a communication session between participant devices according to an exemplary embodiment.

FIG. 3 illustrates an exemplary interface for providing an observer device with access to a communication session between participant devices according to an exemplary embodiment.

FIG. 4 illustrates an apparatus for providing an observer device with access to a communication session between participant devices according to an exemplary embodiment.

### DETAILED DESCRIPTION

Exemplary embodiments will be described more fully hereinafter with reference to the accompanying figures, in which embodiments are shown. This invention may, however, be embodied in many alternate forms and should not be construed as limited to the embodiments set forth herein.

Exemplary embodiments are described below with reference to block diagrams and/or flowchart illustrations of methods, apparatus (systems and/or devices) and/or computer program products. It should be understood that a block of the block diagrams and/or flowchart illustrations, and combinations of blocks in the block diagrams and or flowchart illustrations, can be implemented by computer program instructions. These computer program instructions may be provided to a processor of a general purpose computer, special purpose computer, digital signal processor and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a processor of the computer and/or other programmable data processing apparatus to function in a particular manner, such that the instructions stored in the computer-readable memory produce an article of manufacture including instructions which implement the function/act as specified in the block diagrams and/or flowchart block or blocks.

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.) that runs on a processor such as a digital signal processor, collectively referred to as “circuitry” or “a circuit”. Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate or transport the program for use by or in connection with the instruction execution system, apparatus, or device.

The computer-usable or computer-readable medium may be, for example but not limited to, an electronic, magnetic, optical, electromagnetic or semiconductor system, apparatus or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable optical and/or magnetic media, such as a flash disk or CD-ROM.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

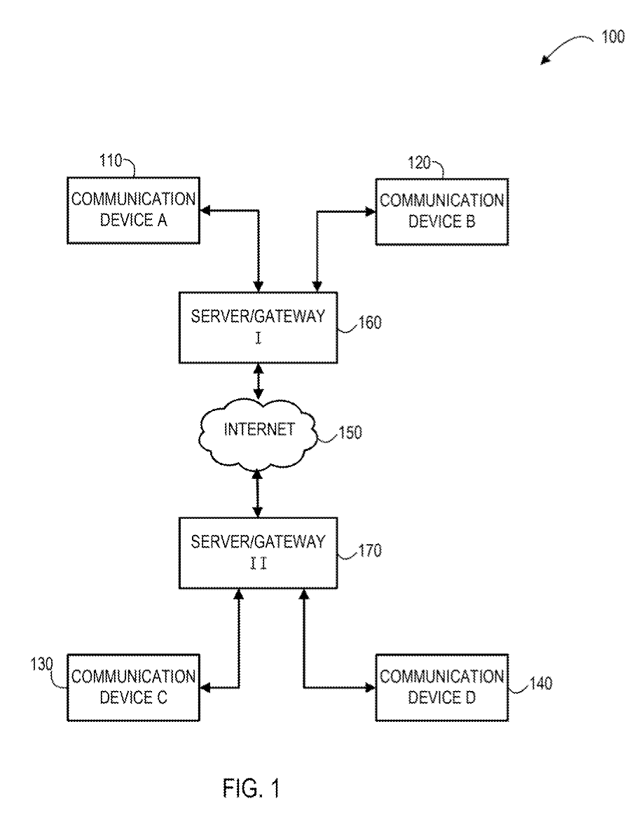

FIG. 1 illustrates a communication environment according to an exemplary embodiment. In the environment shown in FIG. 1, communication devices 110, 120, 130, and 140 communicate via a network 150 and server/gateways 160, 170 to establish a communication session. The communication devices may include, for example, a laptop, a personal computer, a personal digital assistant, a cellular telephone, a VoIP enabled device, a telephone, etc. Though depicted as the Internet for ease of illustration, the network 150 may be a private network, a public network, or a combination thereof, and may be implemented as an Internet Protocol (IP) based network or a network in compliance with another network protocol. For example, the network 150 may include a local area network (LAN), a wide area network (WAN), the Internet, or a combination thereof. For a communication session, such as an instant messaging session, the servers 160 and 170 may act as local and/or universal servers enabling communication between the communication devices via the network 150. For a communication session, such as a VoIP session, the gateways 160 and 170 may act as media gateways or access switches enabling communication between the communication devices via the network 150. Those skilled in the art will appreciate that some details of network architecture for a communication environment have been omitted from FIG. 1 for simplicity of illustration. Further details regarding network architecture for instant messaging and VoIP embodiments are provided, e.g., in U.S. Pat. Nos. 7,346,696 and 7,046,658, respectively. Both of these patents are herein incorporated by reference.

Each of the communication devices 110 (labeled Communication Device A), 120 (labeled Communication Device B), 130 (labeled Communication Device C), and 140 (labeled Communication Device D) may be a participant device or an observer device for any given communication session. The communication session may be an instant messaging session, a VoIP conversation, or any other communication session that may be established via the network 150.

For illustrative purposes, consider communication devices 110 and 120 as participant devices and communication devices 130 and 140 as observer devices for a particular communication session. While in this example, there are two participant devices and two observer devices, it should be appreciated that there may be any number of participant devices and any number of observer devices for a given communication session.

Using devices 110 and 120 as examples of participant devices, a request for initiating a communication session may be initiated by one of these devices, and the request is received at the server/gateway 160. Similarly, using the devices 130 and 140 as examples of observer devices, a request for observing a communication session may be initiated by one or both of these devices, and the request is received by the server/gateway 170. This request may, in turn, be relayed to the server/gateway 160 via the network 150. The server/gateway 160 relays the request to at least one of the communication devices 110, 120. As an alternative, one or both of the communication devices 110, 120 may send a request via the server/gateway 160, network 150, and server/gateway 170 to invite one or both of the communication devices 130, 140 to observe a communication session. The communication device receiving a request for observing a communication session or inviting an observer device to observe a communication session may be referred to as a host participant device, while the communication device participating in the communication session with the host participant device may be referred to simply as a participant device. Although not shown in FIG. 1 in the interest of simplicity of illustration, it should be appreciated that an observer device may be connected to a host participant device directly rather than through a server and a network. For example, if communication device 110 acts as a host participant device, and communication device 120 acts as an observer device, these devices may communicate via any suitable direct communication link rather than communicating through the server/gateway 160.

Following this illustrative example, responsive to the request to initiate a communication session, the server/gateway 160 establishes the session between the communication devices 110 and 120. A connection is also established between one or both of the communication devices 130 and 140 and the host participant device. When the communication session is established between the participant devices, and the connection is established between the host participant device and the observer device communication device, the observer devices may be provided with access to the communication session via the connection between the observer device and the host participant device. As noted above, this access may be provided either upon invitation by one of the participant devices or by request from one of the observer devices. For example, assuming communication device 120 is a host participant device, communication device 120 may invite communication device 130 to observe a communication session between the communication device 120 and the communication device 110. Alternatively, communication device 130 may initiate a request to observe the communication session via a connection to the host participant device, which is the communication device 120 in this scenario.

According to an exemplary embodiment, the requests for initiating a communication session and for observing a communication session may occur in any order or at the same time. For example, an invitation to observe a communication session may be extended by a host participant device to an observer device before or during the communication session. As yet another alternative, an observer device may initiate a request to a host participant device to gain access to the communication session, either before or during the communication session between the participant devices.

According to an exemplary embodiment, the access provided to a communication session for an observer device is controlled by access rules that may be stored in the server/gateway 160, 170 or in the host participant device(s) providing access to the communication session. The rules indicate what sort of access an observer device is permitted to a communication session between participant devices. For example, an observer device may only be allowed to observe fee communication session, may be allowed to communicate with the host participant that invited the observer device to observe the communication session, and/or may be allowed to participate in the communication session.

The access rules may be different for each communication device and for each communication session. For example, some communication devices may be provided limited access as observer devices, depending, e.g., upon the observer device or upon the participant devices involved in a given communication session. The access rules may be predefined but modifiable for each communication device and communication session.

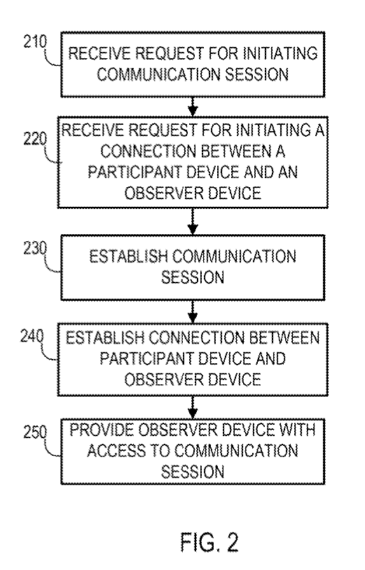

FIG. 2 illustrates a flowchart showing a process for providing an observer device with access to a communication session according to an exemplary embodiment. At step 210, a request for initiating a communication session between participant devices is received. The request may be received at either of the server/gateways 160, 170 from any of the communication devices 110, 120, 130 or 140. At step 220, a request for initiating a connection between a host participant device and an observer device is received at, e.g., a server/gateway 160, 170. The request may be received from a participant device or from an observer device. At step 230, a communication session is established between the participant devices via the server/gateways 160, 170 and the network 150, depending on whether the session is between local participant devices or participant devices connected via the network 150. At step 240, a connection is established between the host participant device and the observer device via the server/gateways 160, 170 and the network 150, depending on whether the host participant device and the observer device are local or connected via the network. At step 250, the observer device is provided with access to the communication session between the participant devices. According to an exemplary embodiment, this access is provided according to access rules maintained in the server/gateway 160, 170 or in the host participant device with which the observer device is connected.

It should be appreciated that the order of steps shown in FIG. 2 is provided for illustrative purposes. The steps may occur in any order desired. For example, step 220 may be performed before step 210, such that the request for initiating a connection between a host participant device and an observer device is received before the request for initiating the connection between the participant devices. Further, step 240 may be performed before step 230, such that a connection is established between the host participant device and the observer device before the connection is established between the participant devices. Further, it should be appreciated that the steps shown in FIG. 2 may be performed for multiple host participant devices and observer devices involved in a communication session, simultaneously or at different times during or before the communication session.

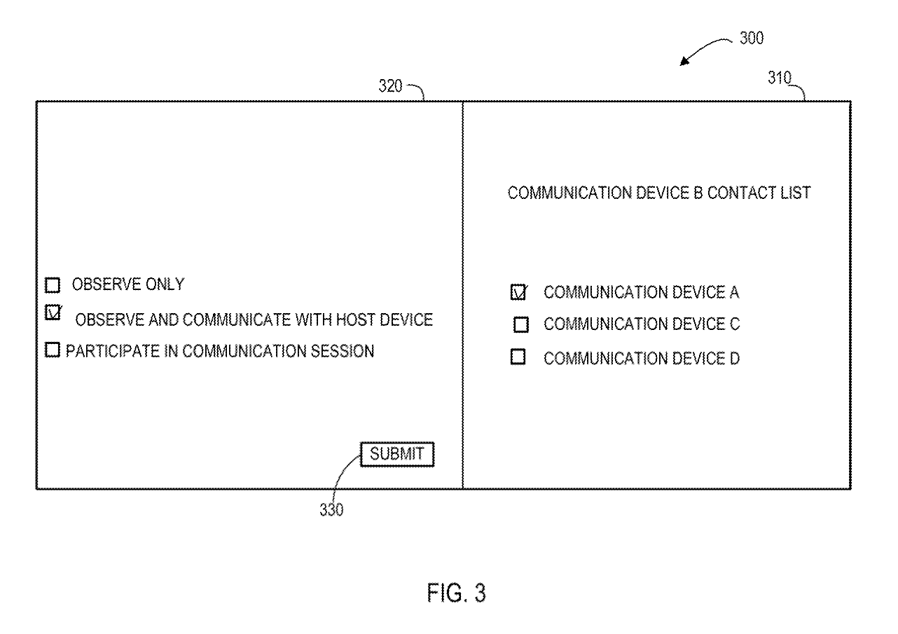

According to exemplary embodiments, access rules for controlling access of an observer device to a communication session may be set up by a user using a user interface. The user interface may be included in a communication device 110, 120, 130, 140 and/or at a server/gateway 160, 170. An example of a user interface is the screen 300 shown in FIG. 3. The screen 300 may be displayed on a computer monitor incorporated within or connected to a communication device 110, 120, 130, 140 and/or a server/gateway 160, 170. According to exemplary embodiments, contacts may be added to and removed from to a communication session, e.g., an instant messaging session, using the screen 300. A contact added to a communication session via the screen 300 may be referred to as an observer device. The observer device may be allowed only to observe a communication session, may be allowed to observe the communication session and communicate with the host participant device, and/or may be allowed to participate in the communication session depending on access rules selectable by a user via the user interface. For example, in an instant messaging session, the observer device may be able to read messages on both sides of a communication session and also may be able to communicate with one or more participants in the instant messaging session. Depending on the access rules, at least the host participant for the communication session is aware of the observer device and may disallow access of the observer device to the communication session, while the other participant in the communication session may not be aware of the access of the observer device.

Referring to FIG. 3, assume for illustrative purposes that the screen 300 represents a user interface for a communication device 120 that is a host participant device for a particular communication session. Section 310 of the screen displays a contact list for the communication device 120. The contact list includes communication devices 110 (represented as Communication Device A), 130 (represented as Communication Device C), and 140 (represented as Communication Device D). Section 320 of the screen displays rules for the communication devices included in the contact list. The contact list and the rules may be maintained in the communication device 120 and/or in a server/gateway, e.g., server/gateway 160. In the example shown in FIG. 3, communication device 110 is selected, and the rule allowing the communication device 110 to observe and communicate with the host participant device is selected. By clicking on Submit button 330, this rule may be stored in a memory (either at the communication device or at the server/gateway 160) such that any time the communication device 110 is an observer device and the communication device 120 is a host participant device, the communication device 110 will be able to observe the communication session between the host participant device 120 and another participant device, and the communication device 110 will also be able to communicate with the host participant device 120. The communication device 110 will not, in this example, be able to participate in the communication session, and any other participants) in the communicate session will be unaware of the access of the communication device 110 to the communication session. However, the rule may be configurable at any time such that the communication device 110 is allowed to participate in the communication session, such that other participants will be aware of the access of the communication device 110 to the communication session.

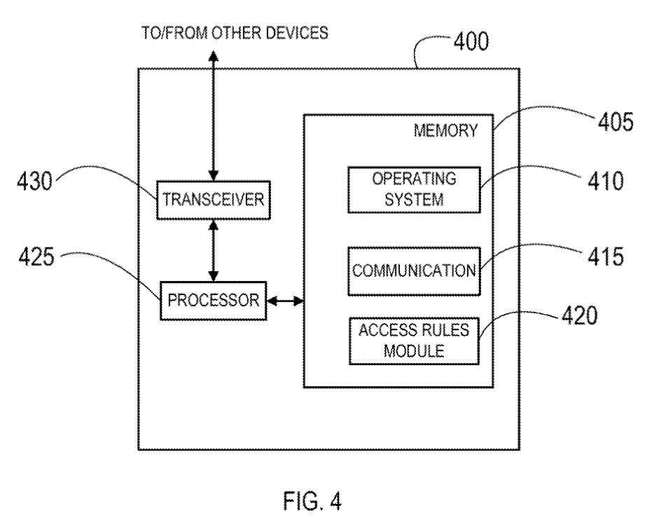

FIG. 4 illustrates an exemplary apparatus for providing an observer device with access to a communication session according to an exemplary embodiment. The apparatus may be included in one or more of the communication devices 110, 120, 130, and 140, and/or in the server/gateways 160, 170. Referring now to FIG. 4, the apparatus 400 includes a processor 425, a transceiver 430, and a memory 405. The processor 425 communicates with the memory 405 via an address/data bus. The processor 425 may be, for example, a commercially available or custom microprocessor. The memory 405 is representative of the one or more memory devices containing the software and data used to facilitate application of the rules for access by an observer device to a communication session in accordance with some embodiments. The memory 405 may include, but is not limited to, the following types of devices: cache, ROM, PROM, EPROM, EEPROM, flash, SRAM, and DRAM. The transceiver 430 includes a transmitter circuit and a receiver circuit, which are used to establish and maintain communication with other devices.

As shown in FIG. 4, the memory 405 may contain multiple categories of software and/or data: an operating system 410, a communication module 415, and an access rules module 420. The operating system 410 generally controls the operation of the access rules module 420. In particular, the operating system 410 may manage the access rules module's software and/or hardware resources and may coordinate execution of programs by the processor 425. The communication module 415 may be configured to manage the communication protocols, including both wireless and wireline protocols, that may be used by the transceiver 430 to communicate with other devices in the communication environment via a network, such as the network 150 shown in FIG. 1. The communication protocols may include, but are not limited to TCP/IP, H.323, etc. The communication module 415 may control conversion of signals received in one type of communication protocols into an appropriate format/protocol for transmission to other devices. For example, a communications module included in a server/gateway 160, 170 may control conversion of an analog or digital signal received from a communication device 110, 120, 130, and/or 140 into a form appropriate for transmission via the network 150.

Although FIG. 4 illustrates an exemplary system for providing an observer device with access to a communication session in accordance with some embodiments, it will be understood that the present invention is not limited to such a configuration but is intended to encompass any configuration capable of carrying out operations described herein.

Computer program code for carrying out operations of devices, terminals, and/or systems discussed above with respect to FIGS. 1-4 may be written in a high level programming language, such as Java, C, and/or C++, for development convenience. In addition, computer program code for carrying out operations of embodiments may also be written in other programming languages, such as, but not limited to, interpreted languages. Some modules or routines may be written in assembly language or even micro code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Exemplary embodiments are described herein with reference to message flow, flowchart and/or block diagram illustrations of methods, devices, and/or computer program products. These message flow, flowchart and/or block diagrams further illustrate exemplary operations for performing file retention in accordance with various embodiments. It will be understood that each message/block of the message flow, flowchart and/or block diagram illustrations, and combinations of messages/blocks in the message flow, flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other, programmable data processing apparatus, create means for implementing the functions specified in the message flow, flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for providing an observer device with access to a communication session between participant devices, comprising:
receiving a request for initiating a communication session between a host participant device and at least one other participant communication device;
establishing, via a communication network, the communication session between the host participant device and the at least one other participant device;
establishing a connection between the host participant device and the observer device device; and
providing the observer device with access to the communication session between the host participant device and the at least one other participant device via the connection between the host participant device and the observer device, wherein awareness of the at least one other participant device of the observer device's access to the communication session depends on access rules controlling access of the observer device to the communication session.

2. The method of claim 1, wherein the connection between the host participant device and the observer device is initiated by the host participant device or by the observer device.

3. The method of claim 1, wherein the connection between the host participant device and the observer device is established via a server or gateway.

4. The method of claim 1, further comprising:
establishing another connection between the host participant device and another observer device or between the at least one other participant device and the other observer device; and
providing the other observer device with access to the communication session between the host participant device and the at least one other participant device via the other connection,
wherein if the other connection is established between the host participant device and the other observer device, awareness of the at least one other participant device of the other observer device's access to the communication session depends on access rules controlling access of the other observer device to the communication session, or
if the other connection is established between the at least one other participant device and the other observer device, awareness of the host participant device of the other observer device's access to the communication session depends on access rules controlling access of the other observer device to the communication session.

5. The method of claim 1, wherein the access rules controlling access of the observer device to the communication session are predefined but modifiable and are stored in the host participant device or stored in a location independent of the host participant device.

6. The method of claim 6, wherein the rules define whether the observer device is only able to observe the communication session, is able to observe but communicate only with the host participant device, and/or is able to communicate with at least one other participant device in the communication session.

7. The method of claim 1, wherein the communication session is an instant messaging session or a Voice over Internet Protocol (VoIP) session.

8. A computer program product comprising a computer readable storage medium having encoded instructions stored thereon that, when executed by a computer including a memory and a processor, cause the computer to:
receive a request for initiating a communication session between a host participant and at least one other participant;
establish the communication session between the host participant device and the at least one other participant;
establish a connection between the host participant device and an observer device; and
provide the observer device with access to the communication session between the host participant device and the at least one other participant device via the connection between the host participant device and the observer device, wherein awareness of the at least one other participant device of the access of the observer device to the communication session depends on access rules stored in the memory for controlling access of the observer device to the communication session.

9. The computer program product of claim 8, wherein the connection between the host participant device and the observer device is imitated by the host participant device or by the observer device.

10. The computer program product of claim 8, wherein the connection between the host participant device and the observer device is established via a server or gateway.

11. The computer program product of claim 8, further comprising instructions that, when executed by the computer, cause the computer to:
establish another connection between the host participant device and another observer device or between the at least one other participant device and the other observer device; and
provide the other observer device with access to the communication session between the host participant device and the at least one other participant device via the other connection,
wherein if the other connection is between the host participant device and the other observer device, awareness of the at least one other participant device of the access to the communication session of the other observer device depends on access rules controlling access of the other observer device to the communication session, or
if the other connection is between the at least one other participant device and the other observer device, awareness of the host participant device to the access of the other observer device to the communication session depends on access rules controlling access of the other observer device to the communication session.

12. The computer program product of claim 8, wherein the access rules are predefined but modifiable by the host participant device or independently of the host participant device.

13. The computer program product of claim 12, wherein the access rules define whether the observer device is only able to observe the communication session, is able to observe but communicate only with the host participant device, and/or is able to communicate with at least one other participant device in the communication session.

14. The computer program product of claim 8, wherein the communication session is an instant messaging session or a Voice over Internet Protocol (VoIP) session.

15. An apparatus for providing an observer device with access to a communication session between participant devices, comprising:
at least one interface for receiving a request for initiating a communication session between participant devices; and
a processor for controlling access to the communication session by the observer device,
wherein the communication session is established between the participant devices, and the processor provides the observer device with access to the communication session between a host participant device and at least one other participant device via connection between the host participant device and the observer device, wherein awareness of the at least one other participant device of the access of the observer device to the communication session depends on access rules controlling access of the observer device to the communication session.

16. The apparatus of claim 15, wherein the connection between the host participant device and the observer device is initiated by the host participant device or the observer device.

17. The apparatus of claim 15, wherein another connection is established between the host participant device and another other observer device or between the at least one other participant device and the other observer device, and wherein the processor provides the other observer device with access to the communication session between the host participant device and the at least one other participant device via the other connection, and
wherein if the other connection is between the host participant device and the other observer device, awareness of the at least one other participant device of the access to the communication session of the other observer device depends on access rules controlling access of the other observer device to the communication session, or
if the other connection is between the at least one other participant device and the other observer device, awareness of the host participant device of access to the communication session of the other observer device depends on access rules controlling access of the other observer device to the communication session.

18. The apparatus of claim 15, wherein the access rules controlling access of the observer device to the communication session are predefined but modifiable and are stored in the host participant device or stored in a location independent of the host participant device

19. The apparatus of claim 18, further comprising a memory for storing the access rules, wherein the rules define whether the observer device is only able to observe the communication session, is able to observe but communicate only with the host participant, and/or is able to communicate with at least one other participant in the communication session.

20. The apparatus of claim 15, wherein the communication session is an instant messaging session or a Voice over Internet Protocol (VoIP) session.
